(19) United States
(12) Patent Application Publication
(10) Pub. No.: US 2013/0273212 A1
(43) Pub. Date: Oct. 17, 2013

(54) PROCESS OF MANUFACTURING A PROTEIN-POLYSACCHARIDE MACROMOLECULAR COMPLEX STRUCTURE CONTAINING ENCAPSULATED ETHYL ALCOHOL AND THE RESULTING PRODUCT-BY-PROCESS

(71) Applicants: Margaret Teresa Thomas Virgallito, Beavercreek, OH (US); Joshua Alan Held, Riverside, CA (US)

(72) Inventors: Margaret Teresa Thomas Virgallito, Beavercreek, OH (US); Joshua Alan Held, Riverside, CA (US)

(21) Appl. No.: 13/444,853

(22) Filed: Apr. 12, 2012

(51) Int. Cl. A23L 1/05; A23P 1/04; A23L 1/03

(52) U.S. Cl. 426/103; 426/573

(57) ABSTRACT

A process of manufacturing a protein-polysaccharide macromolecular complex product containing encapsulated ethyl alcohol and/or other spirits serving to serve as an entertaining and novel non-beverage method of consuming alcohol. The process encapsulates ethyl alcohol and/or other spirits in the amorphous regions of a complex macromolecular structure releasing it only upon chewing and exposure to the environment of the oral cavity. The resulting product is stable and capable of retaining shape and form for extended periods of time at ambient temperature allowing for relatively low-cost commercial manufacture and distribution.

### FIELD OF THE PRESENT DISCLOSURE

This disclosure relates generally to a process of innovatively packaging and presenting ethyl alcohol for personal consumption and to the resulting product produced by such process. This disclosure relates more particularly to a process of fabricating a protein-polysaccharide macromolecular complex non-beverage consumable capable of encapsulating ethyl alcohol and/or other spirits in amorphous regions, holding shape and structure for an extended period of time at ambient room temperature and releasing such encapsulated ethyl alcohol and/or other spirits upon chewing or exposure to the environment of the oral cavity and the resulting product produced by such process.

### BACKGROUND OF THE RELATED ART

Spirits and other alcoholic beverages are served for consumption in a variety of ways. The most basic method of serving an alcoholic beverage is in a glass, appropriately configured to deliver a serving-sized portion of the selected beverage. To increase consumer interest and to compete for market share, purveyors of spirits and other alcoholic beverages often attempt to create alternative and entertaining methods of presenting and serving their products. These methods include innovative packaging and delivery systems ranging from simple improvements in presentation, such as serving ale in a yard glass, to more involved creations, such as adding flavors and/or elaborate garnishing.

There have been considerable efforts in the past to produce ethyl alcohol products in other than beverage form. Various candies and foods containing ethyl alcohol have been envisioned and produced. However, typically the ethyl alcohol content in these products are much diluted and they are often too filling or rich to serve as acceptable methods of consuming more than a very insignificant quantity of alcohol.

One popular non-beverage alternative method of presenting ethyl alcohol for consumption is often referred to as a Jell-O shot. A Jell-O shot is named after the trademark of a popular brand of dessert made from sweetened and flavored gelatin. It is prepared by bringing water to boil and mixing flavored and sweetened gelatin. The resulting mixture is then cooled, ethyl alcohol and/or other spirits are added, and it is poured into serving sized portions. The serving sized portions are subsequently refrigerated allowing the gelatin to form a gel. Once the gel is formed or set, the Jello-O shot is kept refrigerated until shortly before consumption. The refrigeration is required because gelatin, which consists of partially hydrolyzed collagen, forms a thermally reversible gel with water upon cooling that deteriorates if the gel's temperature is subsequently raised above approximately 35 degrees Celsius. While 35 degrees Celsius is above typical ambient room temperature, the gel tends to soften and lose form and structure as it approaches that temperature; therefore, it may not exhibit ideal structural properties at ambient room temperature. Also, if not chilled, a Jell-O shot will begin to melt and become messy immediately upon being handled since human body temperature is above 35 degrees Celsius. These limitations are significant complications to any commercial production effort.

There exists a demand for a more structurally firm and thermally stable, non-beverage delivery system for the consumption of ethyl alcohol. Several attempts have been made to meet this demand, however, in each case, challenges in encapsulation technology and chemistry have proved too great, leading to less desirable or compromised products.

One such attempt is described in U.S. Pat. No. 2,780,355. This disclosure teaches the use of plasticized gelatin shells as an encapsulation shell. However, this method is unsatisfactory because the encapsulated ethyl alcohol will typically diffuse through a gelatin shell due to its low molecular weight unless it is dissolved in a dispersant such as polyethylene glycol. However, the addition of polyethylene glycol does not prevent all leakage as determined upon observation after three weeks and it introduces additional concerns such as its mild toxicity and the further dilution of the ethyl alcohol.

Another such method is described in U.S. Pat. No. 4,507,327. This disclosure teaches an encapsulation process including the steps of dropping a core liquid into a solution of alginic acid salt and calcium salt to form a calcium alginate membrane, waiting for the calcium alginate membrane to form, extracting the core liquid from the capsule, and exchanging it for the desired edible fluid such as ethyl alcohol. However, problems with leaking and oozing exist with this method as well. Further, this method is relatively labor intensive which presents commercialization challenges.

U.S. Pat. No. 5,330,835 teaches yet another method including the use of a viscous liquid that is scarcely miscible with water to form a barrier between the hydrophilic edible liquid containing ethyl alcohol and the gelatin based encapsulation membrane. The scarcely miscible liquid serves to prevent migration of the hydrophilic edible fluid into the encapsulation membrane resulting in a softening of the membrane and the encouragement of bacteria and mold growth. However, concomitant with the beneficial use of a scarcely miscible liquid, such as coffee oil as is taught in this reference, comes the adverse result of leaving an oily or waxy residue in the mouth of the consumer making the consumable less desirable.

There exists a demand for a commercially viable non-beverage delivery system for the consumption of ethyl alcohol that exhibits minimal organoleptic qualities and is not disposed to oozing or leakage.

The present disclosure distinguishes over the related art providing heretofore unknown advantages as described in the following summary.

### BRIEF SUMMARY OF THE INVENTION

The present disclosure describes a process of manufacturing a consumable protein polysaccharide macromolecular complex delivery system capable of encapsulating ethyl alcohol, other spirits, and/or non-alcoholic beverages in amorphous regions of the protein-polysaccharide complex polymeric structure and the product resulting from such process. The retention and release of the resulting encapsulated material is superior to other gel systems in that the encapsulated material is only released upon chewing or exposure to the environment of the oral cavity.

The process of manufacturing the consumable protein-polysaccharide macromolecular product involves complex coacervation of a protein and a polysaccharide that occurs when the constituents are thoroughly mixed in an acidic ethyl alcohol-water solution at approximately forty degrees Celsius. Both the protein and the polysaccharide are soluble in ethyl alcohol, water, and/or an ethyl alcohol-water solution. While in solution, macromolecular hydrogel structures develop as the result of the formation of linkages between the protein and the monomeric constituents of the polysaccharide, with the protein being the cationic polymer and the polysaccharide being the anionic polymer. The ethyl alcohol becomes encapsulated in the amorphous regions of the macromolecular hydrogel structures.

The process includes adding protein to serve as a gelling agent. In a preferred embodiment, the gelling agent is an animal protein such as gelatin. Gelatin may be sourced from pig, beef, chicken, or fish. One can also use dairy proteins or protein sourced from eggs. Carbohydrate gelling agents from vegetable sources such as but not limited to starch, alginate, pectin, agar, carrageenan are acceptable as well, however, they are less desirable than animal proteins because they lack the elastic properties of animal proteins and their tendency to deteriorate upon exposure to an environment similar to the oral cavity.

The process includes adding a polysaccharide to provide enhanced structural integrity to the resulting protein-polysaccharide macromolecular product. In a preferred embodiment the polysaccharide is pullulan. Pullulan is an extracellular water-soluble microbial polysaccharide produced by strains of Aureobasidium pullulans. Pullulan exhibits many qualities that make it useful as an adhesive binder, thickener, and/or an encapsulation agent. Other polysaccharides including but not limited to dextrans having various contents of galactin, isolichen, laminaran, levans, pullulan, and yeast mannan are acceptable as well. The molecular configuration of the polysaccharide controls the manner in which it accommodates mechanical stress, and therefore it plays an important role in modulating ligand binding and its elastic properties.

The resulting consumable protein-polysaccharide macromolecular product is an ideal delivery system for the non-beverage consumption of ethyl alcohol because it displays characteristics of both the protein and the polysaccharide without exhibiting any significant organoleptic qualities. The polysaccharide provides the article of manufacture with an elastic, yet firm, composition that encapsulates ethyl alcohol without leakage or oozing, while the protein provides the article with gelatinous texture and the ability to break down upon chewing and exposure to the environment of the oral cavity.

This disclosure teaches certain benefits in construction and use which give rise to the objectives described below.

A primary objective inherent in the above disclosure is to provide a novel and entertaining process for manufacturing a non-beverage consumable containing ethyl alcohol and/or other spirits.

Another objective of the above disclosure is to provide a process of manufacturing a novel and entertaining

non-beverage consumable product containing ethyl alcohol and/or other spirits capable of retaining shape and form for an extended period of time at ambient room temperature.

A further objective of the above disclosure is to provide a process of manufacturing a novel and entertaining non-beverage consumable product containing ethyl alcohol and/or other spirits capable of releasing such alcohol and other spirits upon chewing or exposure to the environment of the oral cavity.

A still further objective of the above disclosure is to provide a process of manufacturing a novel and entertaining non-beverage consumable product containing ethyl alcohol and/or other spirits that exhibit minimal organoleptic qualities.

A yet still further objective of the above disclosure is to provide a process of manufacturing a novel and entertaining non-beverage consumable product containing ethyl alcohol and/or other spirits that will not soften or dissolve when exposed to ambient room temperature water.

Other features and advantages of the present invention will become apparent from the following more detailed description, taken in conjunction with the accompanying drawings, which illustrate, by way of example, an exemplary embodiment of the products resulting from the presently disclosed process.

### BRIEF DESCRIPTION OF THE SEVERAL VIEWS OF THE DRAWING(S)

The accompanying drawings illustrate exemplary implementations and are part of the specification. The illustrated implementations are proffered for purposes of example and not for purposes of limitation. Illustrated elements of the resulting product will be designated by numbers. Once designated, an element will be identified by the identical number throughout. In such drawings:

FIG. 1 is a plan view of an exemplary embodiment of the presently described consumable product-by-process containing ethyl alcohol and/or other spirits;

FIG. 2 is a perspective view of a cross section of an exemplary embodiment of the presently described consumable product-by-process containing ethyl alcohol and/or other spirits.

FIG. 3 is a perspective view of an exemplary embodiment of the presently described consumable product-by-process containing ethyl alcohol and/or other spirits shown being grasped between the index finger and thumb of a human hand.

### DETAILED DESCRIPTION OF AN EXEMPLARY EMBODIMENT

The drawing figures illustrate an exemplary embodiment of the protein-polysaccharide product-by-process in at least one of its preferred, best mode embodiments, which is further defined in detail in the following process description. Those having ordinary skill in the art may be able to make alterations and modifications to the process that is described herein without departing from the spirit and scope of the disclosure. Further, it must be understood that the product-by-process that is illustrated is set forth only for the purposes of example and that it should not be taken as a limitation in the scope of the presently described process.

Described now in detail is a process of manufacturing a novel and entertaining non-beverage protein-polysaccharide consumable containing encapsulated ethyl alcohol and/or other spirits. The process yields a product that exhibits a desired blend of physical and organoleptic properties because of the unique individual properties of both the protein and polysaccharide subparts and because of the synergistic manner in which they combine. The process involves combining between 10% and 25% by weight water-soluble protein, between 0.1% and 7.5% by weight water-soluble polysaccharide, and between 60% to 90% by weight ethyl alcohol solution. In an alternative non-alcoholic embodiment, rather than the introducing an ethyl alcohol solution the process may include adding between 60% and 90% by weight water-soluble sweetener and/or flavoring.

The protein in the non-beverage protein-polysaccharide is preferably an animal protein. As previously explained, the animal protein gelatin is the product of denaturation or to disintegration of collagen. Collagen exhibits multiple alpha chains that are held together with several different but easily reducible cross links. The protein is made up of peptide triplets, glycerin −X-Y, where X and Y can be any one of the amino acids but proline has a preference for the X position and hydroxyproline has a preference for the Y position. Approximately 1050 amino acids produce an alpha-chain with a left-handed proline helix conformation.

There are two main types of gelatin. Type A, with an isotonic point between 7 and 9, is derived from collagen with only acid-based pretreatment. Type B, with an isotonic point between 4.8 and 5.2, is the result of an alkaline pretreatment of collagen. Both varieties of gelatin are acceptable component proteins for the presently disclosed process and a selection may be made based on the varying physical properties, such as gel strength, to suit particular preferences.

The polysaccharide called for in the manufacturing process is preferably pullulan. However, other polysaccharides including, but not limited to, dextrans having various contents of galactin, isolichen, laminaran, levans, pullulan, and yeast mannan are acceptable as well. Dextrans have a series of pyranose rings comprising five carbon atoms and one oxygen atom. The pyranose rings are linked, creating a backbone of alpha linked d-glucopyranosyl repeating units. The pyranose ring is the structural unit controlling the elasticity of the polysaccharide. The elasticity is a function of the force-induced elongation of the pyanose rings which transitions the ring's structure from a chair-like to a boat-like conformation.

There are three classes of dextrans that can be differentiated by structural architecture. Class 1 dextrans comprise an alpha (1→6) linked d-glucopyranosyl backbone modified with small side chains of monomeric d-glucose branches with alpha (1→2), alpha (1→3), and alpha (1→4) linkages. Class 2 dextrans (alternans) contain a backbone of alternating alpha (1→3) linked and alpha (1→6) linked d-glucopyranosyl units with alpha (1→3) linked monomeric constituent branches. Class 3 dextrans (mutans) have a backbone structure of consecutive alpha (1→3) linked d-glucopyranosyl units with alpha (1→6) linked monomeric constituent branches.

When both the protein and the polysaccharide are dissolved in either a water-ethyl alcohol solution and/or a water-sweetener and/or flavoring solution at a temperature elevated to approximately 35-40 degrees Celsius, linkages form between the protein and the monomeric constituents of the polysaccharide with the protein being the cationic polymer and the polysaccharide being the anionic polymer forming macromolecular hydrogel structures that encapsulate the solvent. The complex coacervation can form numerous modes of linkage between the protein and the polysaccharide due to the diverse nature of the polysaccharide monomeric constituents. The resulting macromolecular hydrogel structures may be transferred into molds and cooled, forming firm yet resulting products.

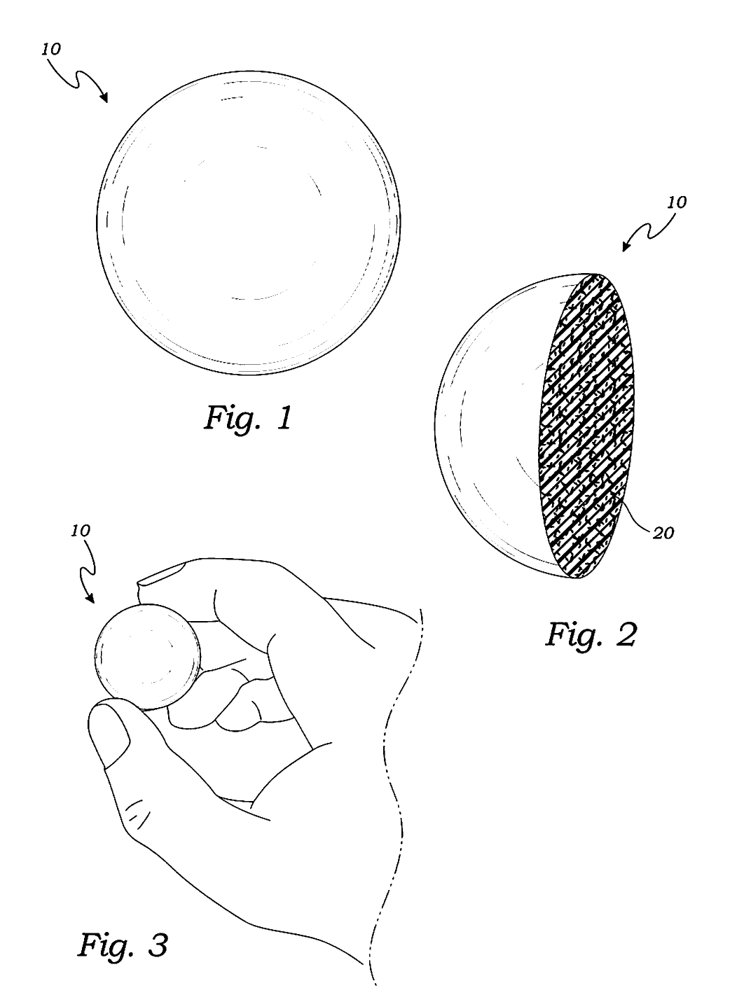

FIG. 1 illustrates an exemplary spherically molded embodiment of the presently described product-by-process 10. The spherical shape is for example only, as the product may be molded to any desired shape dictated by the process. In fact, the product may also assume many forms including: micro-sphere; macro-sphere; particle; film; agglomerate; filament; or alternative solid forms.

FIG. 2. illustrates a spherical molded embodiment of the presently described non-beverage consumable product-by-process 10 cut in half. This perspective illustrates that the resulting product 10 is composed of the same consistency throughout, with the ethyl alcohol and/or other spirit and/or sweetener and flavoring encapsulated within the amorphous regions of the protein-polysaccharide macromolecular complex, as opposed to being encapsulated in a free-liquid form within a shell or impermeable barrier. This encapsulation method allows a consumer to bite into the product without concern of releasing or spilling the free-liquid ethyl alcohol within.

FIG. 3 illustrates the same spherically molded embodiment of the product of the presently disclosed product as depicted in FIG. 1 and FIG. 2, but places it in the context of a human hand for scale. The exemplary embodiment is sized such that a human could consume the article of manufacture in one or two bites. This approximate size is preferred, however, it is not meant to be limiting. The article of manufacture may be produced to any scale desired.

Various specific examples of the above described process follow:

### Example 1

A 20% protein and polysaccharide solution is prepared by dissolving 15 grams of pork gelatin and 5 grams of pullulan into 75.5 grams of an ethyl alcohol solution containing between 50% and 60% water by weight and between 40% and 50% ethyl alcohol by weight. Dissolution is performed in a closed vacuum reactor elevated to between 35 and 40 degrees Celsius. The solution is mechanically stirred at 150 rpm until the protein and polysaccharide solution appear fully wetted, and then stirring is continued for an additional 30 minutes to ensure complete dissolution. A combination of plasticizer, flavor, and sweetener is mixed until homogeneous, and then slowly added into the protein polysaccharide solution and stirred at 150 rpm for 15 minutes. A vacuum is pulled at 20 psi and the mixture is stirred for an additional 15 minutes. The resulting solution is then transferred into spherical molds and cooled to 3 to 5 degrees Celsius and held at temperature for 15 minutes. The molds are then slowly raised to 22 degrees Celsius and the resulting protein-polysaccharide products are removed from the molds.

The macromolecular products produced by this process are stable and exhibit an ability to hold shape and form throughout a temperature range from 5 degrees to 30 degrees Celsius. Further, the products produced by this process demonstrate an ability to withstand between 8 and 10 Newtons of compression force. When force is applied, the products deform elastically and fully recover when the force is removed. Compression testing was performed using a SHIMPO FGV 10X.

Dissolution tests were run on products produced by this method as well, using both de-ionized and carbonated water. The products were placed into 200 grams of water at 24 degrees Celsius. The water was mechanically stirred at 100 rpm for 24 hours. In each case, upon removal from the water, the products were slightly swollen but displayed no signs of dissolution. While still in the swollen state, the products were retested for compression and withstood between 4 and 8 Newtons of compression force. The products exhibited greater deformation than before but the deformation remained fully elastic and therefore the products returned to their original shape and form when the compression force was removed.

The protein-polysaccharide products produced by this process were also subjected to sensory tests to gauge alcohol flavor intensity. Ten individuals, both male and female, were asked to chew the articles of manufacture for 5 minutes while describing the alcohol flavor intensity on a scale from 1 to 12 every 30 seconds. All of the participant's alcohol flavor intensity ratings closely corresponded, beginning with 1 and increasing linearly to a score of 9 or 10 at the end of the 5 minute period. The test results demonstrated that the products produced by the presently disclosed method effectively release the ethyl alcohol upon chewing and exposure to the environment of the oral cavity as desired.

### Example 2

A 25% protein and polysaccharide solution is prepared by dissolving 20 grams of pork gelatin and 5 grams of pullulan into 70.5 grams of an ethyl alcohol solution. The ethyl alcohol solution contained between 50% and 60% water by weight and between 40% and 50% ethyl alcohol by weight. Dissolution is carried out in a closed vacuum reactor at a temperature between 35 and 40 degree Celsius, and the solution is stirred at 150 rpm mechanically until the protein and polysaccharide is completely dispersed. Stirring is then continued for an additional 30 minutes to assure complete dispersion.

Next, a combination of plasticizer, flavor, and sweetener is mixed until homogeneous and slowly added to the protein-polysaccharide solution while mechanically stirring at 150 rpm for 15 minutes. The stirring is continued for an additional 15 minutes under a 20 psi vacuum.

The resulting mixture is poured into spherical molds and cooled to 3 to 5 degrees Celsius, held at temperature for 15 minutes, then allowed to warm to 22 degrees Celsius and removed from the molds. As in Example 1, the resulting protein-polysaccharide products are stable and demonstrated an ability to hold shape and form throughout a temperature range from 5 degrees to 30 degrees Celsius.

The products produced by the Example 2 process are able to withstand 12 to 15 Newtons of compression force exerted by a SHIMPO FGV 10X. The products produced by the Example 2 process deformed elastically while withstanding 12 to 15 Newtons of compression force. This is an increase over the 8 to 10 Newtons of compression force endured by the products produced by the Example 1 process.

The products produced by the Example 2 process were also subjected to dissolution testing as set forth in Example 1, and similar to the Example 1 products, the Example 2 products exhibited no discernible dissolution but were slightly swollen after 24 hours of soaking. When tested for compression strength in the swollen state, Example 2 products endured 6 to 10 Newtons of force but resumed shape and form when the force was removed.

### Comparison Study

A comparison test was performed to demonstrate the beneficial synergistic effects of the both protein and polysaccharide constituents of the process. The test was conducted by performing processes in which either the protein or the polysaccharide was omitted and comparing physical properties of the resulting products to the products that resulted from a process that included both the protein and the polysaccharide. The ingredient of all three test processes are listed in the chart below.

| | | | Protein- |
|---|---|---|---|
| | Protein | Polysaccharide | Polysaccharide |
| | Macromolecular | Macromolecular | Macromolecular |
| Ingredients | Structure | Structure | Structure |
| Glycerin | 0.50% | 0.50% | 0.50% |
| Gelatin | 8% | | 15% |
| Agar | | 2.50% | |
| Pullulan | | 5% | 5% |
| Flavor | 2% | 2% | 2% |
| Sweetener- | 1% | 1% | 1% |
| Superose | | | |
| Ethyl Alcohol- | | | 76.50% |
| Water Solution | | | |
| Water | 68.5% | 69% | |
| Ethyl Alcohol | 20% | 20% | |
| Total | 100.00% | 100.00% | 100.00% |

Each sample was prepared by the same essential process. First the primary ingredients (e.g., the protein, polysaccharide, or both, and the water and ethyl alcohol) were mechanically stirred at 150 rpm in a closed vacuum reactor at 35 to 40 degrees Celsius for 30 minutes beyond the point in time in which the ingredients appeared to be dispersed. Then the plasticizer, sweetener, and flavor were added while stirring continued for an additional 15 minutes. Next a 20 psi vacuum was pulled on the reactor, and stirring was continued for an additional 15 minutes. The resulting mixture was transferred to spherical molds and reduced in temperature to 3 to 5 degrees Celsius, held at temperature for 15 minutes, allowed to slowly increase in temperature to 22 degrees Celsius. The resulting products were subsequently removed from the molds.

The products resulting from the differing processes exhibited significantly different physical characteristics. The protein-only macromolecule structures were weak in shape and form immediately upon being removed from the mold. When tested for compression strength using a SHIMP FGV 10X, the protein-only products lost shape and form during testing after being exposed to only 0.9 Newtons of compression force. Further, at ambient temperature, the protein-only macromolecular products began to melt after only 60 minutes.

The products resulting from the polysaccharide-only process performed even worse. Immediately upon being removed from the mold, the polysaccharide-only products exhibited a very limited ability to hold shape and form, and began to melt upon being exposed to ambient conditions for approximately 15 minutes. When tested for compression, the polysaccharide-only products withstood 0 Newtons of compression force and broke apart during testing.

As expected, the products that resulted from protein-polysaccharide process demonstrated a robust ability to hold both shape and form at ambient temperatures for an extended period of time. When tested for compression, the protein-polysaccharide products withstood 9.7 Newtons of compression force. The structure deformed elastically during compression but returned to its pretesting mold shape when the compression force was removed. The stability and durability of the protein-polysaccharide products allow for relatively simple, low-cost commercial production and distribution.

The enablements described in detail above are considered novel over the prior art of record and are considered critical to the operation of at least one aspect of the presently described process and resulting product, and to the achievement of the above-described objectives. The words used in this specification to describe the instant embodiments are to be understood not only in the sense of their commonly defined meanings, but to include by special definition in this specification: structure, material, or acts beyond the scope of the commonly defined meanings. Thus, if an element can be understood in the context of this specification as including more than one meaning, then its use must be understood as being generic to all possible meanings supported by the specification and by the word(s) describing the element.

The definitions of the words or drawing elements described herein are meant to include not only the combination of elements which are literally set forth, but all equivalent structures, materials or acts for performing substantially the same function in substantially the same way to obtain substantially the same result. In this sense, it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, substitutions, now or later known to one with ordinary skill in the art, are defined to be within the scope of the defined elements. This disclosure is thus meant to be understood to include what is specifically

What is claimed is:

1. A process of manufacturing a protein-polysaccharide macromolecular complex article of manufacture for consuming ethyl alcohol or other spirits, the process comprising steps of:
(a) mixing between 10% and 25% by weight water-soluble protein, between 0.1% and 7.5% by weight water-soluble polysaccharide with between 60% and 90% by weight ethyl alcohol solution until full dissolution;
(b) cooling the resulting mixture below 5 degrees Celsius for 10 to 15 minutes; and
(c) raising the temperature of the resulting mixture to ambient temperature.

2. A process as in claim 1 wherein step (a) comprises:
(a) mixing between 10% and 25% by weight water-soluble protein, between 0.1% and 7.5% by weight water-soluble polysaccharide with between 60% and 90% by weight ethyl alcohol solution until full dissolution in a closed vacuum reactor at a temperature between 25 and 40 degrees Celsius.

3. A process as in claim 2 further comprising the step of:
mixing between 0.125% and 0.2% by weight of a plasticizer with the mixture until full dissolution prior to cooling.

4. A process in claim 3 further comprising the steps of:
mixing between 0.25% and 2.5% by weight of an acidulant with the mixture until full dissolution prior to cooling.

5. A process in claim 4 further comprising the step of:
mixing flavoring with the mixture until full dissolution prior to cooling.

6. A process as in claim 5, wherein said plasticizer is a plasticizer selected from a group consisting of glycerin, propylene glycol, sorbitol, xylitol, lecithin, medium chain triglycerides, and any combination thereof.

7. An article of manufacture as in claim 6, wherein said water-soluble polysaccharide is pullulan.

8. A process as in claim 7, wherein said water-soluble polysaccharide is a polysaccharide selected from the group consisting of galactan, isolichen, laminaran, lavans, pullulan, yeast mannan, and any combination thereof.

9. A process as in claim 8, wherein said acidulant is an acidulant selected from a group consisting of tannic acid, lactic acid, ascorbic acid, acetic acid, citric acid, maltic acid, adipic acid, fumaric acid, and any combination thereof.

10. A process of manufacturing a non-beverage article of manufacture for consuming ethyl alcohol or other spirits, the process comprising steps of:
(a) mixing between 10% and 25% by weight water-soluble protein, between 0.1% and 7.5% by weight water-soluble polysaccharide with between 60% and 90% by weight non-alcoholic flavor solution until full dissolution;
(b) cooling the resulting mixture below 5 degrees Celsius for 10 to 15 minutes; and
(c) raising the temperature of the resulting mixture to ambient temperature.

11. A process as in claim 10 wherein step (a) comprises:
(a) mixing between 10% and 25% by weight water-soluble protein, between 0.1% and 7.5% by weight water-soluble polysaccharide with between 60% and 90% by weight ethyl alcohol solution until full dissolution in a closed vacuum reactor at a temperature between 25 and 40 degrees Celsius.

12. A process as in claim 11 further comprising the step of:
mixing between 0.125% and 2% by weight of a plasticizer with the mixture until full dissolution prior to cooling.

13. A process in claim 12 further comprising the steps of:
mixing between 0.25% and 2.5% by weight of an acidulant with the mixture until full dissolution prior to cooling.

14. A process in claim 13 further comprising the step of:
mixing flavoring with the mixture until full dissolution prior to cooling.

15. A protein-polysaccharide macromolecular product produced according to the process of claim 1.

16. A protein-polysaccharide macromolecular product produced according to the process of claim 9.

17. A protein-polysaccharide macromolecular product produced according to the process of claim 10.

18. A protein-polysaccharide macromolecular product produced according to the process of claim 11.

19. A protein-polysaccharide macromolecular product produced according to the process of claim 13.

20. A protein-polysaccharide macromolecular product produced according to the process of claim 14.
